(19) United States
(12) Patent Application Publication
(10) Pub. No.: US 2013/0192052 A1
(43) Pub. Date: Aug. 1, 2013

(54) NUT FOR FIXING COMPONENTS TO A PROFILED ELEMENT BY SCREWED MEANS AND ASSEMBLING METHOD

(71) Applicant: GIMATIC S.p.A., Roncadelle (IT)

(72) Inventor: Giuseppe MAFFEIS, Roncadelle (IT)

(73) Assignee: GIMATIC S.P.A., Roncadelle (IT)

(21) Appl. No.: 13/750,048

(22) Filed: Jan. 25, 2013

(30) Foreign Application Priority Data
Jan. 27, 2012 (IT) BS2012A000011

(51) Int. Cl. F16B 41/00

(52) U.S. Cl. CPC F16B 41/002
USPC 29/525.02; 411/103

(57) ABSTRACT

The invention concerns a nut for removably fixing any component or device to a longitudinal groove (11) of a profiled element (10) by screwed means. The nut in composed of a body (20) having a base surface (21), a front surface (22), two first opposite sides (23) and two second opposite sides (24), and it has centrally a threaded hole (25) extending from the front surface (22) to the base surface (21) along to an axis (X). The nut body (20) is moreover provided with a rounded area (27) joining every first (23) to every second (24) adjoining side at two diagonally opposite corners, and with side roundings (28) at least in an area of the base surface (21) adjacent to, and joining with, both the two second opposite sides (24). The nut is inserted through the outer opening of a profile groove with combined tilt/oscillation and then rotation movements around the axis of the threaded hole for its arrangement in the use and engage position with the hooking teeth in said groove.

### TECHNICAL FIELD OF THE INVENTION

The present invention concerns a nut for removably fixing any component or device to a longitudinal groove of a profiled element—hereinafter simply named profile—by screwed means, as well as a method for applying the nut to the profile.

### STATE OF THE ART

Profiles elements are already known from the art, or rather extruded profiles, having a longitudinal groove along at least one side thereof, to fix a component or device by at least one fixing nut and one locking bolt screwing one to the other, that is to say a reversible fastening system to allow the removable removal and/or repositioning of every component or device fixed to the profile according to needs.

A known profile, which is widely popular and used, has a body with at least one longitudinal groove, substantially with a U-shaped section, having an inner or bottom part and an opening facing to the outside of the profile. The inner part of the groove could have any shape and width, whereas the outer opening is delimited by two parallel edges and has anyway a width smaller than that of the inner part.

Then, in particular, parallel edges delimiting the outer opening could be each provided with a hooking tooth facing to the groove bottom. For example, in the afore said profile, the width of the longitudinal opening could be of about 6 mm and the distance between the hooking teeth along the edges of said opening is of about 7.2 mm.

The fastening of every component or device to the profile, as afore described, is made by the use of at least one fixing nut inserted into the profile groove, and of at least one locking bolt engaging, at one side, with a part of the fixing nut and at the other side with a component or device to be fixed to the profile.

According to a known method of implementation and assembling, the fixing nut is centrally provided with a threaded hole and frontally, at sides opposite to said hole, with parallel throats intended to be combined with the hooking teeth along the opening edges of the longitudinal groove of the profile.

The so- arranged fixing nut is inserted into the profile groove at one profile end and it is free to slide therein until the desired position is reached. The locking bolt, which could be previously and subsequently screwed in the thread hole of the nut, is then tightened until the component or device to be fixed is locked, also because of the coupling, if any, of the nut throats with the hooking teeth at the profile opening sides. However, this assembling method has the drawback that if there is the need of adding some other components in addition to those already fastened to the profile, some components have to be disassembled so that a new fixing nut, to which the additional component has to be fastened, could be inserted along the groove.

According to another known method of implementation and assembling, the fixing nut is still provided with a threaded hole and two parallel throats at sides opposite to said hole. Irrespective of how much its length is, however in this case the nut has a width size in order to be inserted edgewise into the groove through the outer opening of the profile and then to be turned over inside the groove and arranged in parallel to the bottom of the latter so as to screw the respective locking bolt through the outer opening.

This technical solution has anyway a drawback because, in order to be able to insert the fixing nut edgewise through the outer opening, the width thereof has to be limited, also considering that the groove depth is relative and could impede or obstruct the overturning of the nut flat inside the groove. In addition, because of the limited width of the fixing nut and in order not to weaken the mechanical strength, also the threaded hole made therein must have a little diameter, also meaning the use of a more little bolt, in any case different from what is usually employed.

According to another known method of implementation and assembling, the fixing nut has a parallelogram—like shape and it is provided with a threaded stem acting as a fixing bolt.

In particular, then the fixing nut has such a shape to be able to pass through the outer opening of the profile with an insertion movement perpendicularly to the groove bottom and to be subsequently turned of 90° in the inner part of the groove to the point of engaging two opposite ends of the nut, which may have parallel throats, with the teeth at the side of the outer opening whereas the threaded stem extends through such an opening in order to constrain the component to be fixed to the profile therewith.

This solution too, even if practical, is not free of drawback coming from the fact that nut and threaded stem must be made integrally, as a threaded hole obtained in the nut for the screwing of a bolt, could weaken the mechanical strength of the nut improperly because of its limited width.

### OBJECT OF THE INVENTION

Main object of the present invention is to provide a nut for fixing components or devices to a groove of a profile known per se, able to eliminate all drawbacks of the known art, with high mechanical strength even if provided with a threaded hole with a considerable diameter according to the width of the outer opening of the profile groove, as well as having universal use and simple and easy to be applied to the profile even in presence of components already present on the profile, or between them.

Such an object is reached with a nut according to claim 1 and its applying method to the profile according to claim 6.

Substantially, the nut has a shaped body provided with a central threaded hole extending from a front surface to a base surface of said body and a couple of hooking throats resulting from parts opposite to the threaded hole and intended to engage with the hooking teeth proper of the profile the nut is to be applied thereto.

In particular, then the nut body has rounded parts at its side and base in order to be inserted through the outer opening of a profile groove with combined tilt/oscillation and then rotation movements around the axis of the threaded hole for its arrangement in the use and engage position with the hooking teeth in said groove.

Afterwards, when the nut is inserted and settled in the profile groove, a locking bolt can be screwed to its threaded hole, allowing any component or device to be firmly fastened to the profile itself.

### BRIEF DESCRIPTION OF THE DRAWINGS

Further details of the invention will be evident from the following description course made with reference, by way of example only and without limitation, to the attached drawings, in which:

FIGS. 1 and 2 shown schematically the fixing nut according to the invention represented from opposite parts;

FIGS. 3, 4, 5 show, respectively, the side, top and bottom views of the nut;

FIG. 6 shows a cross section of the nut;

FIGS. 7, 8, 9 and 10 show, in sequence, the insertion steps of the fixing nut in the groove of a profile with the latter in a perspective view and with a breaking at the nut; and

FIGS. 11, 12, 13 and 14 show the insertion steps of a nut in the groove of a profile with the latter depicted in a cross view.

### DETAILED DESCRIPTION OF THE INVENTION

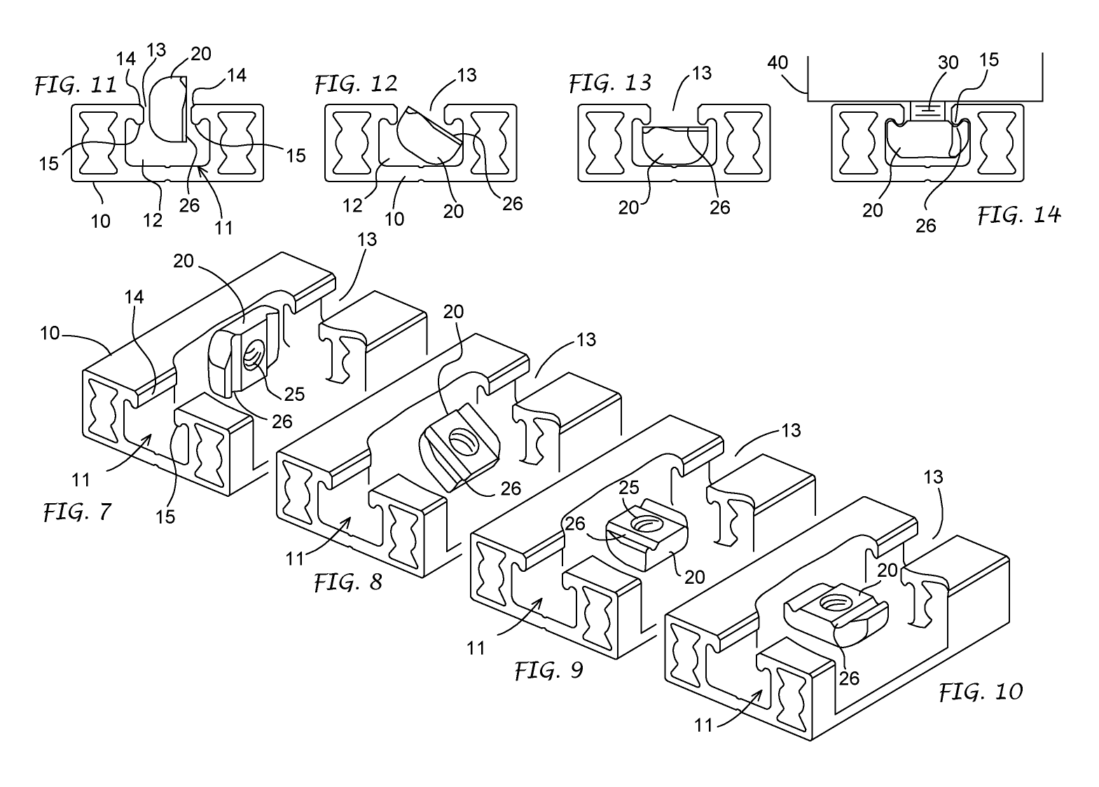

In said drawings a part of the extruded profile 10 is shown and has, along at least one of its sides, at least one longitudinal groove 11 intended to accommodate at least one fixing nut 20 according to the invention in order to fix any component or device 40, the latter being schematically depicted in FIG. 10, to said profile, by means of at least one locking bolt 30.

In particular, the longitudinal groove 11 of the profile 10 has an inner part 12 which is open outwardly through a longitudinal opening 13. Whereas the inner part 12 of the groove 11 can have various shape, width and depth, even if prearranged, the outer opening 13 has a width smaller than the width of said inner part 12 and it is delimited by two parallel edges 14, each of them being preferably provided with a substantially V-shaped hooking tooth 15, facing towards the bottom of the inner part of the groove.

For example, and as for a well known profiled element, the outer opening of the profile groove has a width between the edges of about 6 mm and the distance between the cusps of the couple of hooking teeth is of about 7.2 mm.

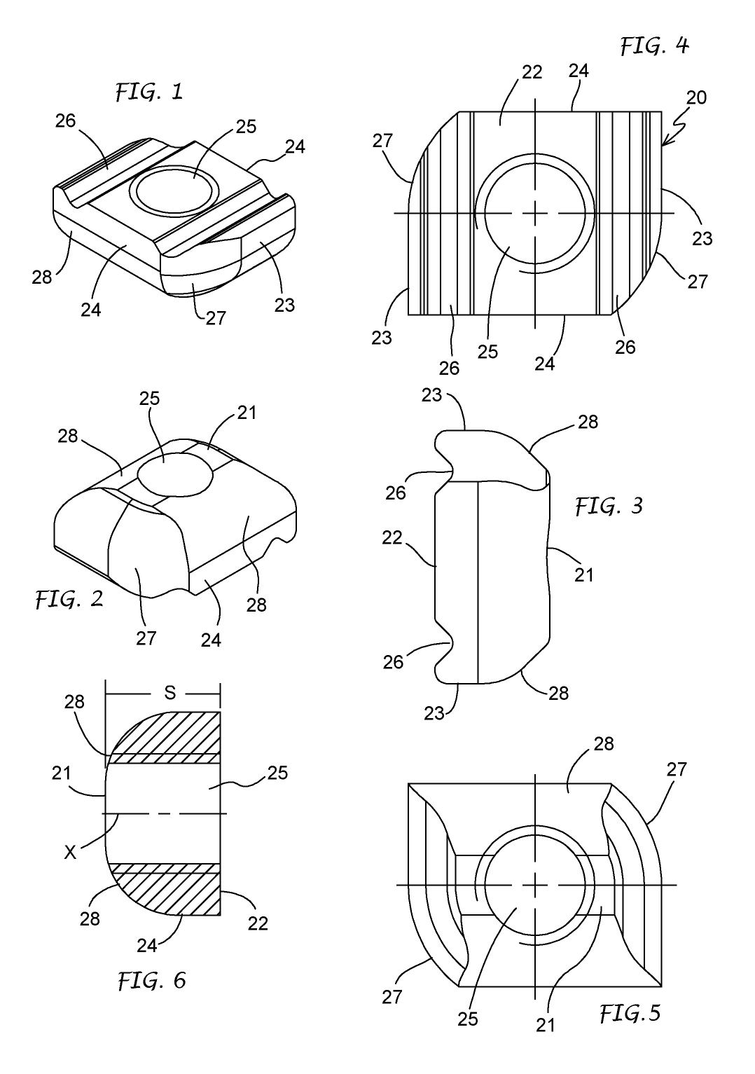

The fixing nut 20 has a substantially parallelepiped body, but some of its parts are shaped (FIGS. 1-6). More precisely, it has a base surface 21, a front surface 22, two first opposite sides 23 and two second opposite sides 24, and it is centrally provided with a threaded hole 25 which extends from the front surface 22 to the base surface 21 along an X axis.

In addition, on its front surface 22, the fixing nut 20 has two parallel throats 26 having a shape corresponding to that of the hooking teeth 15 along the edges of the outer opening of the groove 11 of the profile 10. As shown in detail in FIGS. 1 and 3, the hooking throats 26 are obtained at opposite sides of the central hole 25 and they run in parallel with the two first opposite sides 23 of the body of the nut 20.

In particular the nut body has, in the direction of the X axis of the threaded hole 25, a thickness S (FIG. 6) suitable with the width of the opening 13 of the groove 11 of the profile 10. In this way, for example, where the outer opening 13 of the groove 11 of the profile 10 has a width of about 6 mm, the thickness S of the nut body could be of about 4.5 to 5.0 mm. Then, approximately for its use with a profile 10, as in the afore described example, the nut could have a length of about 8-9 mm in the direction of the two first opposite sides 23, that is the hooking throats 26, and a length of about 10-11 mm in the direction of the two second opposite sides 24.

Then according to the invention the body of the fixing nut 20 has a rounded area 27 with a radius of about 4.5-5.5 mm in both its two diagonally opposite angles. Basically, each rounded area extends between, and joins, a first side 23 with a second side 24 which are adjoining to the body, whereas the other two diametrically opposite angles can be right or even only slightly joined (FIGS. 4 and 5).

In addition, the body of the nut 20 is provided with side roundings 28 at least in an area of the base surface 21 adjoining each of the two second opposite sides 24 of said body (FIGS. 1, 2, 3 and 6), the roundings having a radius of about 2.5-3.0 mm, for example.

The locking bolt 30 is provided to be screwed in the central hole 25 of the nut 20, such a hole and subsequently the nut being preferably of M5 type.

Thanks to its specific features, the fixing nut 20 can be easily inserted in every part of the groove 11 of the profile 10 with combined oscillation movements firstly and rotation movements around the X axis, advantageously in presence of, and between, components already fastened to the profile 10.

More precisely, the nut 20 is firstly introduced through the opening 13 of the groove 11, arranged edgewise on one of the second sides 24 and with the hooking throats 26 directed towards the bottom of said groove, as shown in FIGS. 7 and 11. Then the nut adopts a tilted position and can be oscillated in the inner part 12 of the groove 11 taking advantages of the side roundings 28, as shown in FIGS. 8 and 12, until it is completely arranged underneath the hooking teeth 15 along the edges 14 of the opening 13, in parallel to the bottom of the groove 11 and with its front surface 22 facing to such an opening 13. In such a position the hooking throats 26 of the nut 20 are directed transversally of the opening 13 and then of the hooking teeth 15 along the edges 14 of the opening 13 of the groove 11, as shown in FIGS. 9 and 13. For a correct and final use arrangement, then the nut has to be turned of 90° around the X axis for its arrangement with the respective hooking throats 26 aligned and next to the hooking teeth 15 of the groove 11 of the profile 10, as shown in FIGS. 10 and 14.

Such a rotation could be obtained by the subsequent screwing of the locking bolt 30 in the threaded hole 25 of the nut and could be limited by the rest of the first sides 23 of the nut against the flanks of the inner part of the groove. By screwing the bolt 30 into the threaded hole of the nut, the latter is pulled and locked against the hooking teeth for a safe and, on the other hand, reversible and adjustable fastening of the desired component to the profile.

1. A nut for removably fixing any component or device to a longitudinal groove of a profiled element by screwed means, the nut comprising a body having a base surface, a front surface, two first opposite sides and two second opposite sides, having centrally a threaded hole extending from the front surface to the base surface along to an axis, and said body being provided with a rounded area joining every first to every second adjoining side at two diagonally opposite corners, and with side roundings at least in an area of the base surface adjacent to, and joining with, both the two second opposite sides.

2. A nut according to claim 1, wherein the longitudinal groove of the profile has an inner part opened outwardly through a longitudinal opening having a width lower than the inner part and delimited by two parallel edges, each of which provided with a hooking tooth facing towards the groove bottom, the nut body has a thickness on the directrix of the axis of the threaded hole lower than the width of said opening, and said front surface has two hooking throats from opposite sides of the threaded hole, parallel to the two first opposite sides of said body, designed to engage with said hooking teeth.

3. A nut according to claim 1, wherein the longitudinal groove of the profile has an outer opening with a width of about 6 mm, the nut body has a thickness of about 4.5 to 5.0 mm.

4. A nut according to claim 2, wherein the body nut may have a length of about 8-9 mm in the direction of the two first opposite sides, that is of the hooking throats, and a length of about 10-11 mm in the direction of the two opposite second sides.

5. A nut according to claim 1, wherein the rounded area joining every first to every second adjoining side in diagonally opposite parts of the body nut has a radius of about 4.5-5.5 mm, and the side roundings between the base surface and the two second opposite sides have a radius of about 2.5-3.0 mm.

6. A method for applying a nut to a profile provided with at least one longitudinal groove having an inner part opened outwardly through a longitudinal opening having a width lower than the inner part and delimited by two parallel edges, each of which provided with a hooking tooth facing towards the groove bottom, the method comprising:
at first inserting the nut through the opening of the groove, disposed edgewise on one of second sides of the nut and with hooking throats of the nut facing towards the bottom of said groove;
then, tilting the nut and turning the nut over in the inner part of the groove taking advantage of side roundings of the nut until the nut is disposed completely underneath the edges of the opening, parallel to the bottom of the groove and with a front surface of the nut facing towards said opening, then the hooking throats on said front surface being oriented transversally to the opening and the hooking teeth along said edges;
later on, turning the nut 90° around an axis of a threaded hole of the nut to arrange the nut with the respective hooking throats aligned with, and next to, the hooking teeth;
finally, screwing a bolt to the threaded hole to tighten the nut against the hooking teeth along the edges of the opening of the groove to fasten every component or device to the profile.

7. A method according to claim 6, wherein the nut rotation in the inner part of the profile throat could be determined by the screwing of the locking bolt in the threaded hole of the nut and could be limited by the rest of the first sides of the nut against flanks of the inner part of the groove.

8. A nut according to claim 2, wherein the longitudinal groove of the profile has an outer opening with a width of about 6 mm, the nut body has a thickness of about 4.5 to 5.0 mm.
